(19) United States
(12) Patent Application Publication
(10) Pub. No.: US 2020/0200039 A1
(43) Pub. Date: Jun. 25, 2020

(54) CLEANING SYSTEM FOR A GAS TURBINE ENGINE

(71) Applicant: GENERAL ELECTRIC COMPANY, Schenectady, NY (US)

(72) Inventor: Peng Wang, Shanghai (CN)

(21) Appl. No.: 16/306,139

(22) PCT Filed: Jun. 24, 2016
(86) PCT No.: PCT/CN2016/087052

§ 371 Date: Nov. 30, 2018

(51) Int. Cl. F01D 25/00; B08B 9/027; G05D 7/06

(52) U.S. Cl. CPC F01D 25/002; G05D 7/0635; B08B 9/027

(57) ABSTRACT

A cleaning system for a gas turbine engine is disclosed, which includes a fluid tank with fluid therein, a nozzle device for spraying the fluid from the fluid tank, a connection line for connecting the fluid tank with the nozzle device, and a computer. The connection line includes a pump device for pumping the fluid from the fluid tank to the nozzle device, a flow meter for measuring a flow rate of the fluid passing through the pump device, and a regulatory valve. The pump device, the flow meter and the regulatory valve are operably coupled with the computer, and the computer controls the regulatory valve to automatically regulate a flow rate of the fluid entering into the nozzle device based on a measured flow rate of the fluid passing through the pump device and a fluid flow demand.

### BACKGROUND

This disclosure relates generally to the aircraft engine field, and more particularly to a cleaning system for a gas turbine engine.

As shown in FIG. 1, a gas turbine engine 800 generally includes, in serial flow order, a compressor section R1, a combustion section R2, a turbine section R3 and an exhaust section R4. In operation, air enters an inlet of the compressor section R1 where one or more compressors progressively compress the air until it reaches the combustion section R2. Fuel is mixed with the compressed air and burned within the combustion section R2 to provide combustion gases. The combustion gases are routed from the combustion section R2 through a hot gas path defined within the turbine section R3 and then exhausted from the turbine section R3 via the exhaust section R4. The expanding combustion gases drive a turbine within the turbine section R3 and also result in thrust used for propelling the aircraft.

With operation of the gas turbine engine 800, some contaminant such as dust, debris and other materials can build-up onto internal components of the gas turbine engine 800 over time. These contaminants can affect engine components and overall performance of the aircraft. Accordingly, in order to maintain fuel efficiency and power output of the gas turbine engine 800, as well as the avoidance of potential engine failure, compressor and turbine sections, and the gas path of the gas turbine engine are necessary to be routinely cleaned. Usually, a conventional cleaning system having a nozzle device is used to inject a cleaning fluid, for example water, to the engine core by the nozzle device for cleaning the gas turbine engine 800. The conventional cleaning system usually does not have a tight control for a flow rate of fluid injected into the gas turbine engine 800. Under the circumstance, if the flow rate of fluid injected into the gas turbine engine 800 is too high, the cleaning fluid, for example water, will be caused to enter a forward sump 806 and/or an after sump 807 of the gas turbine engine 800, which may lead to corrosion of components. Thus, such uncontrolled cleaning fluid into the engine core can cause damage to the gas turbine engine 800. However, if the flow rate of fluid injected into the gas turbine engine 800 is too low, the gas turbine engine 800 won't be washed cleanly and efficiently.

Therefore, there is a need for an improved cleaning system to control a flow rate of fluid injected into the gas turbine engine.

### BRIEF DESCRIPTION

In one embodiment, the present disclosure provides a cleaning system for a gas turbine engine. The cleaning system comprises a fluid tank with fluid therein, a nozzle device for spraying the fluid from the fluid tank, a connection line for connecting the fluid tank with the nozzle device, and a computer. The connection line comprises a pump device for pumping the fluid from the fluid tank to the nozzle device, a flow meter for measuring a flow rate of the fluid passing through the pump device, and a regulatory valve. The pump device, the flow meter and the regulatory valve are operably coupled with the computer, and the computer controls the regulatory valve to automatically regulate a flow rate of the fluid entering into the nozzle device based on a measured flow rate of the fluid passing through the pump device and a fluid flow demand

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram of an exemplary gas turbine engine;

FIG. 2 is a schematic diagram of a cleaning system for a gas turbine engine in accordance with an embodiment of the present disclosure; and

FIG. 3 is a schematic diagram of a cleaning system for a gas turbine engine in accordance with another embodiment of the present disclosure.

### DETAILED DESCRIPTION

Embodiments of the present disclosure will be described herein below with reference to the accompanying drawings. In the following description, well-known functions or constructions are not described in detail to avoid obscuring the disclosure in unnecessary detail.

Unless defined otherwise, technical and scientific terms used herein have the same meaning as is commonly understood by one of ordinary skill in the art to which this disclosure belongs. The terms “first”, “second”, “third” and the like, as used herein do not denote any order, quantity, or importance, but rather are used to distinguish one element from another. Also, the terms “a” and “an” do not denote a limitation of quantity, but rather denote the presence of at least one of the referenced items. The term “or” is meant to be inclusive and mean either or all of the listed items. The use of “including,” “comprising” or “having” and variations thereof herein are meant to encompass the items listed thereafter and equivalents thereof as well as additional items. In addition, the terms “connected” and “coupled” are not restricted to physical or mechanical connections or couplings, and can include electrical connections or couplings, whether direct or indirect.

### Embodiment 1

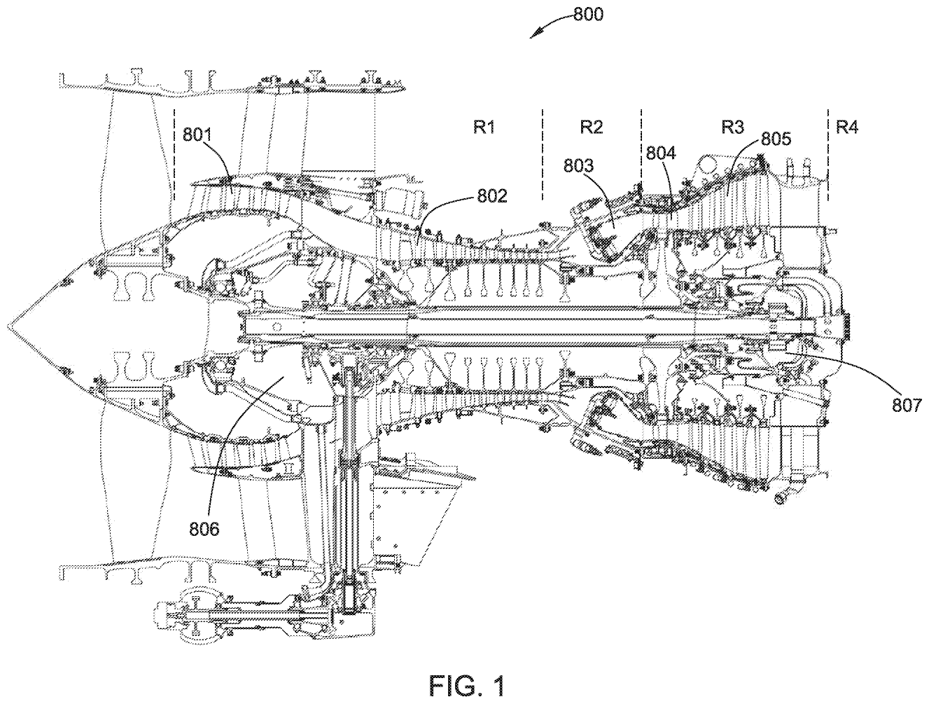

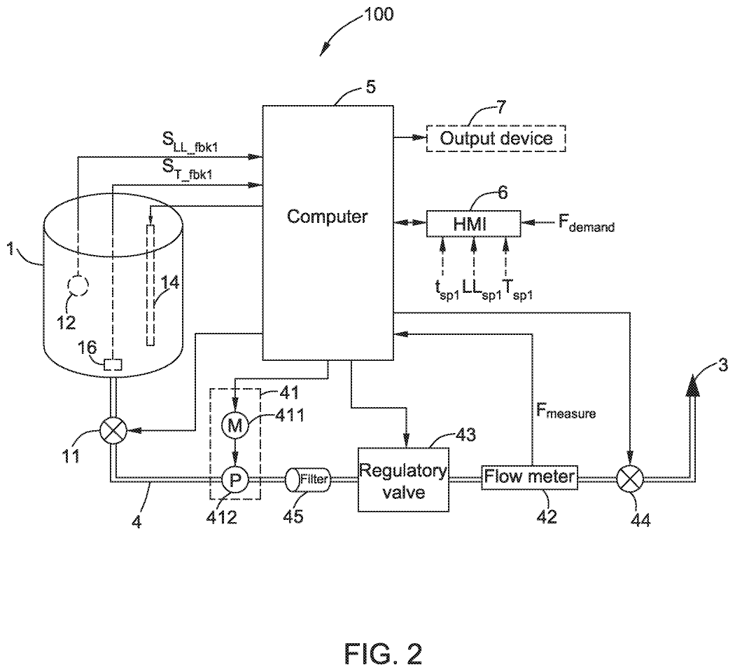

FIG. 2 illustrates a schematic diagram of a cleaning system 100 in accordance with an embodiment of the present disclosure. As shown in FIG. 2, the cleaning system 100 may be used for cleaning a gas turbine engine 800 (as shown in FIG. 1). The cleaning system 100 may include a fluid tank storing fluid therein. In one embodiment, the fluid tank may include a clean water tank 1 storing clean water therein. The volume of the clean water tank 1 may be for example larger than 120 L.

The cleaning system 100 may include a nozzle device 3 and a computer 5. The clean water tank 1 may be in fluid communication with the nozzle device 3 via a connection line 4. The connection line 4 may include a pump device 41 which may be operably coupled with the computer 5. As an example, the pump device 41 may include an electrical motor 411 and a motor-driven pump 412. The electrical motor 411 may be operably connected with the computer 5 for driving the pump 412 to operate. The clean water from the clean water tank 1 may be pumped to the nozzle device 3 by the pump device 41. Then, the nozzle device 3 may spray the clean water from the clean water tank 1 to the gas turbine engine 800 for cleaning the gas turbine engine 800.

The connection line 4 may have a tank valve 11. The clean water tank 1 is coupled to the pump device 41 via the tank valve 11. The tank valve 11 may be operably connected with the computer 5, e.g., through a wired or wireless communications network, so the computer 5 may automatically control to open or close the tank valve 11.

The cleaning system 100 may include a human machine interface (HMI) 6 coupled with the computer 5 and configured to allow an operator to read and write data for controlling and/or configuring the cleaning system 100. The human machine interface 6 may be an interface which permits interaction between the operator and the cleaning system 100. The human machine interface 6 may include for example, a control panel, a display screen or the like. The human machine interface 6 may have two functions of input and output. Thus, the operator may tell the cleaning system 100 what to do, to make requests of the cleaning system 100, or to operate the cleaning system 100 via the human machine interface 6. Furthermore, the cleaning system 100 may remind the operator to execute corresponding actions via the human machine interface 6. For example, writing data may include receiving input or commands from the operator, and reading data may include generating warning signals, such as status indication lights. Controlling and/or configuring the cleaning system 100 may for example include, but not limited to, open or close various kinds of valves, select fluid tanks, start the electrical motor 411, start or shut down heating devices and etc.

In order to automatically and accurately control a flow rate of the fluid entering into the nozzle device 3, the cleaning system 100 may further include a flow meter 42 and a regulatory valve 43 which are disposed in the connection line 4. The flow meter 42 and the regulatory valve 43 may be operably connected with the computer 5. The flow meter 42 may measure a flow rate Fₘₑₐₛᵤᵣₑ of the fluid passing through the pump device 41, and feed the measured flow rate Fₘₑₐₛᵤᵣₑ of the fluid back to the computer 5. The computer 5 may receive a fluid flow demand F_{demand} input from the operator via the human machine interface 6, or the fluid flow demand F_{demand} may also be stored in the computer 5 in advance. The fluid flow demand F_{demand} may depend on type of the gas turbine engine 800 to be cleaned. For example, for CFM56 engine which is produced by a 50/50 Joint Venture between GE company and Snecma company, the fluid flow demand F_{demand} may be 20 L/min. The computer 5 may control the regulatory valve 43 to automatically regulate a flow rate of the fluid entering into the nozzle device 3 based on the measured flow rate Fₘₑₐₛᵤᵣₑ of fluid passing through the pump device and the fluid flow demand F_{demand}. The regulatory valve 43 may regulate the flow rate of the fluid by adjusting a rotation speed of the pump 412. In an optional implementation, the regulatory valve 43 may for example include a ratio regulatory valve for steplessly regulating the flow rate of the fluid entering into the nozzle device 3.

By using the flow meter 42 and the regulatory valve 43, and cooperative control of the computer 5, the cleaning system 100 of the present disclosure can realize automatic and accurate control for the flow rate of the fluid entering into the nozzle device 3, and reduce interference of human factors, for example insufficient cleaning duration, inconsistent flow rate of fluid and etc. The cleaning system 100 of the present disclosure may thus ensure the effect of engine cleaning. The cleaning system 100 of the present disclosure can achieve efficient cleaning of the gas turbine engine 800 without damaging the gas turbine engine 800.

With continued reference to FIG. 2, the cleaning system 100 may further include a switch valve 44. The switch valve 44 may be for example an electro-magnetic switch valve. The switch valve 44 may be coupled between the regulatory valve 43 and the nozzle device 3 and may be operably connected with the computer 5.

The computer 5 may receive a cleaning duration setpoint t_{SP1} input from the operator via the human machine interface 6, or the cleaning duration setpoint t_{SP}1 may also be stored in the computer 5 in advance. The computer 5 may control the switch valve 44 to automatically shut down based on the cleaning duration setpoint t_{SP1}, for example 2 minutes. The cleaning of the gas turbine engine 800 may be conducted for just under 2 minutes. Once the cleaning duration setpoint t_{SP1} is reached, the computer 5 may control the switch valve 44 to automatically shut down. Thus, the switch valve 44 may stop the fluid from being introduced to the nozzle device 3. The cleaning system 100 of the present disclosure can ensure the cleaning duration accurately. In addition, the cleaning cycle may be run once or may be repeated two or more times. The number of cleaning cycle may be set via the human machine interface 6, and the computer 5 may perform corresponding control according to the number of cleaning cycle.

The cleaning system 100 may further include a liquid level transducer 12. The liquid level transducer 12 may detect a liquid level in the clean water tank 1, and may send a liquid level feedback signal S_{LL_fbk1} to the computer 5. The computer 5 may receive a liquid level setpoint LL_{SP1} input from the operator via the human machine interface 6, or the liquid level setpoint LL_{SP1} may also be stored in the computer 5 in advance.

When the detected liquid level in the clean water tank 1 is below the liquid level setpoint LL_{SP1}, the computer 5 may generate a warning signal via the human machine interface 6 reminding the operator to add clean water into the clean water tank 1, and control the tank valve 11 to close so as to stop the clean water tank 1 from supplying the clean water to the nozzle device 3. The warning signal may include for example a sound signal, a light signal, or a combination thereof. When the detected liquid level in the clean water tank 1 is higher than the liquid level setpoint LL_{SP1}, the computer 5 may control the tank valve 11 to open so as to allow the clean water tank 1 to supply the clean water to the nozzle device 3. The nozzle device 3 may spray the clean water to the gas turbine engine 800 from an inlet of the gas turbine engine 800 or from a rear side of the gas turbine engine 800. With reference to FIG. 1, the clean water may pass a boost 801, a high pressure compressor (HPC) 802, a combustor 803, a high pressure turbine (HPT) 804 and a low pressure turbine (LPT) 805 of the gas turbine engine 800 so as to complete cleaning process of the gas turbine engine 800. During the cleaning process, certain amount of clean water may also pass other parts of the gas turbine engine 800. In addition, the computer 5 may calculate an actual output fluid flow based on liquid level feedback signals from the liquid level transducer 12 before and after cleaning process.

In one embodiment, the cleaning system 100 may further include a heating device 14 and a temperature transducer 16. The heating device 14 may be, for example, a heating rod, and may heat the clean water in the clean water tank 1. The heating device 14 may be operably connected with the computer 5. The warm clean water may be supplied to the nozzle device 3 for improving the effect of cleaning. The temperature transducer 16 may detect a water temperature in the clean water tank 1, and may send a water temperature feedback signal S_{T_fbk1} to the computer 5. The computer 5 may control the heating device 14 according to the water temperature feedback signal S_{T_fbk1}. The computer 5 may receive a temperature setpoint T_{SP1} input from the operator via the human machine interface 6, or the temperature setpoint T_{SP1} may also be stored in the computer 5 in advance. The temperature setpoint T_{SP1} may be for example 70-90° C. The heating device 14 may heat the clean water in the clean water tank 1 until the water temperature reaches the temperature setpoint T_{SP1}. When the detected water temperature in the clean water tank 1 reaches the temperature setpoint T_{SP1}, the computer 5 may control the heating device 14 to automatically shut down, and the computer 5 may also control the tank valve 11 to open for performing the cleaning process.

The cleaning system 100 may further include a filter 45. The filter 45 may be disposed in the connection line 4, and may filter out impurities in the fluid. As an example, the filter 45 may be arranged downstream from the pump device 41, for example, between the pump device 41 and the regulatory valve 43. When the electrical motor 411 starts and the cleaning system 100 is in normal operation, if the measured flow rate Fₘₑₐₛᵤᵣₑ of the fluid passing through the pump device 14 is lower than a flow rate threshold, it could because of block of the filter 45, in this condition, the computer 5 may automatically shut down the electrical motor 411 so as to avoid the electrical motor 411 to operate under loads.

In an optional embodiment, the cleaning system 100 may further include an output device 7. The output device 7 may be operably coupled with the computer 5. The output device 7 may be, for example, a SD card, a printer or the like. The output device 7 may record and output data in association with the cleaning process. The data in association with the cleaning process may include, for example, the actual output fluid flow in the cleaning process, the water temperature in the clean water tank 1, the cleaning duration and the like.

The cleaning system 100 of the present disclosure may achieve exact control of the fluid flow rate for cleaning and accurate control of the cleaning duration, and may thus ensure the effect of engine cleaning. Furthermore, the cleaning system 100 of the present disclosure is an automatic system, and is a very simple and convenient system.

### Embodiment 2

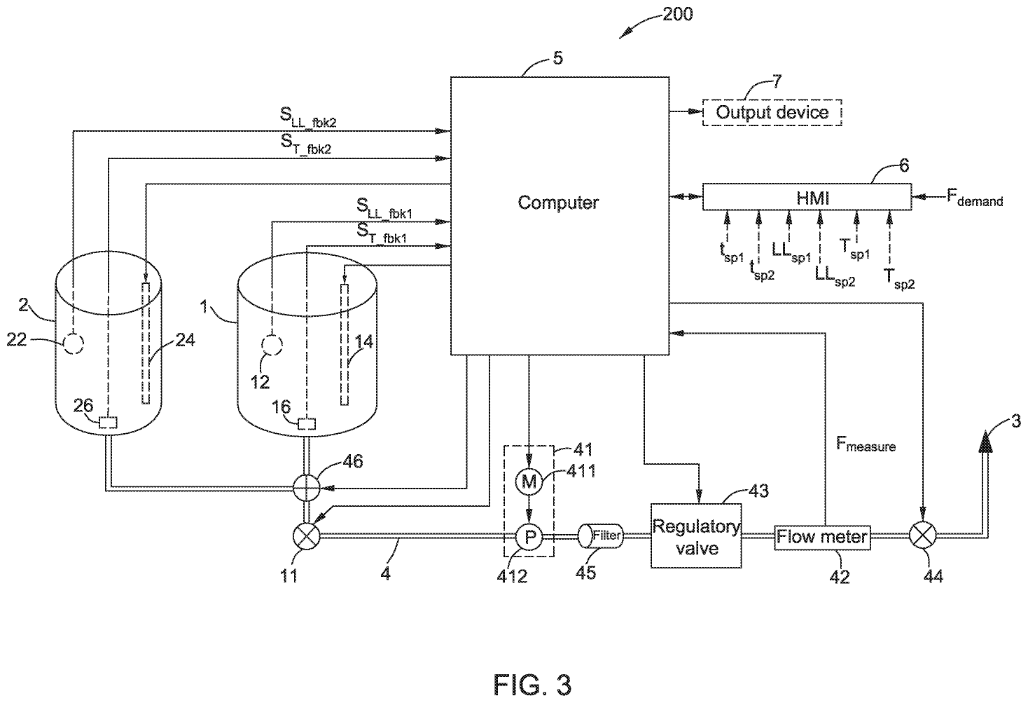

FIG. 3 illustrates a schematic diagram of a cleaning system 200 for cleaning the gas turbine engine 800 in accordance with another embodiment of the present disclosure. As shown in FIG. 3, different from the cleaning system 100 of FIG. 2, the fluid tank in the cleaning system 200 of FIG. 3 may further include a detergent tank 2 storing detergent liquid therein besides the clean water tank 1. The detergent tank 2 may be coupled to the pump device 41 via the tank valve 11. The volume of the detergent tank 2 may be for example larger than 40 L.

Referring to FIG. 3, in this embodiment, the cleaning system 200 may further include a selection valve 46. The clean water tank 1 and the detergent tank 2 may be respectively connected to the tank valve 11 via the selection valve 46. The selection valve 46 may be operably coupled with the computer 5, and the computer 5 may control the selection valve 46 to automatically switch between the clean water tank 1 and the detergent tank 2.

By controlling the selection valve 46, the operator may select one of the clean water tank 1 and the detergent tank 2 as needed. The operator may accomplish control of the selection valve 46 via the human machine interface 6 so as to realize the selection of the clean water tank 1 or the detergent tank 2. For example, when the computer 5 controls the selection valve 46 to select the clean water tank 1 and controls the tank valve 11 to open, the clean water from the clean water tank 1 may be pumped to the nozzle device 3 by the pump device 41. Then, the nozzle device 3 may spray the clean water to the gas turbine engine 800 for cleaning the gas turbine engine 800. When the computer 5 controls the selection valve 46 to select the detergent tank 2 and control the tank valve 11 to open, the detergent liquid from the detergent tank 2 may be pumped to the nozzle device 3 by the pump device 41. Then, the nozzle device 3 may spray the detergent liquid to the gas turbine engine 800 for cleaning the gas turbine engine 800. The addition of the detergent liquid may further improve the effect of engine cleaning.

In the actual cleaning process, the operator may select a cleaning mode via the human machine interface 6. For example, in one embodiment, the cleaning mode may include from clean water cleaning to detergent cleaning and then to clean water cleaning. In another embodiment, the cleaning mode may include from detergent cleaning to clean water cleaning. The computer 5 may control the selection valve 46 to perform corresponding switching actions according to the selected cleaning mode so as to complete selection of the fluid.

Similarly, the cleaning system 200 may further include a liquid level transducer 22 for detecting a liquid level in the detergent tank 2. The liquid level transducer 22 may send a liquid level feedback signal S_{LL_fbk2} to the computer 5. The computer 5 may receive a liquid level setpoint LL_{SP2} input from the operator via the human machine interface 6, or the liquid level setpoint LL_{SP2} may also be stored in the computer 5 in advance.

When the detected liquid level in the detergent tank 2 is below the liquid level setpoint LL_{SP2}, the computer 5 may generate another warning signal via the human machine interface 6 reminding the operator to add detergent liquid into the detergent tank 2, and control the tank valve 11 to close so as to stop the detergent tank 2 from supplying the detergent liquid to the nozzle device 3. Another warning signal may also include for example a sound signal, a light signal, or a combination thereof. When the detected liquid level in the detergent tank 2 is higher than the liquid level setpoint LL_{SP2}, the computer 5 may control the tank valve 11 to open so as to allow the detergent tank 1 to supply the detergent liquid to the nozzle device 3.

The cleaning system 200 may further include a heating device 24 for heating the detergent liquid in the detergent tank 2, and a temperature transducer 26 for detecting a liquid temperature in the detergent tank 2.

The heating device 24 may be, for example, a heating rod, and may be operably connected with the computer 5. The temperature transducer 26 may send a liquid temperature feedback signal S_{T_fbk2} to the computer 5. The computer 5 may control the heating device 24 according to the liquid temperature feedback signal S_{T_fbk2}. The computer 5 may receive a temperature setpoint T_{SP2} input from the operator via the human machine interface 6, or the temperature setpoint T_{SP2} may also be stored in the computer 5 in advance. The temperature setpoint T_{SP2} may be for example 70-90° C. The heating device 24 may heat the detergent liquid in the detergent tank 2 until the liquid temperature reaches the temperature setpoint T_{SP2}. When the detected liquid temperature reaches the temperature setpoint T_{SP2}, the computer 5 may control the heating device 24 to automatically shut down, and the computer 5 may also control the tank valve 11 to open for performing the cleaning process.

The cleaning system 200 of the present disclosure is an automatic system, and is a very simple and convenient system. The cleaning system 200 of the present disclosure can realize automatic and accurate control for the flow rate of the fluid entering into the nozzle device 3 and the cleaning duration, reduce interference of human factor, and may thus ensure the effect of engine cleaning and achieve efficient cleaning of the gas turbine engine 800 without damaging the gas turbine engine 800.

While the disclosure has been illustrated and described in typical embodiments, it is not intended to be limited to the details shown, since various modifications and substitutions can be made without departing in any way from the spirit of the present disclosure. As such, further modifications and equivalents of the disclosure herein disclosed may occur to persons skilled in the art using no more than routine experimentation, and all such modifications and equivalents are believed to be within the spirit and scope of the disclosure as defined by the following claims.

What we claim is:

1. A cleaning system for a gas turbine engine comprising:
a fluid tank with fluid therein;
a nozzle device for spraying the fluid from the fluid tank;
a connection line for connecting the fluid tank with the nozzle device, wherein the connection line comprises:
a pump device for pumping the fluid from the fluid tank to the nozzle device;
a flow meter for measuring a flow rate of the fluid passing through the pump device; and
a regulatory valve; and
a computer, wherein the pump device, the flow meter and the regulatory valve are operably coupled with the computer, and the computer controls the regulatory valve to automatically regulate a flow rate of the fluid entering into the nozzle device based on a measured flow rate of the fluid passing through the pump device and a fluid flow demand.

2. The cleaning system of claim 1, further comprising:
a human machine interface coupled with the computer and configured to allow an operator to read and write data, wherein the computer receives the fluid flow demand via the human machine interface.

3. The cleaning system of claim 1, further comprising:
a switch valve coupled between the regulatory valve and the nozzle device;
wherein the computer controls the switch valve to automatically shut down based on a cleaning duration setpoint.

4. The cleaning system of claim 1, further comprising:
a filter disposed in the connection line and configured to filter out impurities in the fluid.

5. The cleaning system of claim 1, further comprising:
a liquid level transducer for detecting a liquid level in the fluid tank.

6. The cleaning system of claim 5, wherein the liquid level transducer sends a liquid level feedback signal to the computer, and the computer generates a warning signal when a detected liquid level is below a liquid level setpoint.

7. The cleaning system of claim 1, further comprising:
a heating device for heating the fluid in the fluid tank.

8. The cleaning system of claim 7, further comprising:
a temperature transducer for detecting a fluid temperature in the fluid tank.

9. The cleaning system of claim 8, wherein the temperature transducer sends a fluid temperature feedback signal to the computer and the computer controls the heating device to automatically shut down when a detected fluid temperature reaches a temperature setpoint.

10. The cleaning system of claim 1, wherein the connection line has a tank valve operably connected with the computer, the fluid tank is coupled to the pump device via the tank valve, and the computer automatically controls to open or close the tank valve.

11. The cleaning system of claim 10, wherein the fluid tank comprises a clean water tank with clean water therein.

12. The cleaning system of claim 11, wherein the fluid tank further comprises:
a detergent tank with detergent therein, wherein the detergent tank is coupled to the pump device via the tank valve.

13. The cleaning system of claim 12, further comprising:
a selection valve operably coupled with the computer, wherein the clean water tank and the detergent tank are respectively coupled to the tank valve via the selection valve, and the computer controls the selection valve to automatically switch between the clean water tank and the detergent tank.

14. The cleaning system of claim 1, further comprising:
an output device coupled with the computer and configured to record and output data in association with cleaning process.

15. The cleaning system of claim 1, wherein the regulatory valve comprises a ratio regulatory valve for steplessly regulating the flow rate of the fluid entering into the nozzle device.
